(19) United States
(12) Patent Application Publication
(10) Pub. No.: US 2024/0208521 A1
(43) Pub. Date: Jun. 27, 2024

(54) GROUND WORKING VEHICLE WITH ADJUSTABLE PARAMETERS BASED ON GEOGRAPHICAL LOCATION

(71) Applicant: THE TORO COMPANY, Bloomington, MN (US)

(72) Inventor: Peter M. Arendt, Richfield, MN (US)

(21) Appl. No.: 18/538,289

(22) Filed: Dec. 13, 2023

Related U.S. Application Data
(60) Provisional application No. 63/434,410, filed on Dec. 21, 2022.

(51) Int. Cl. B60W 50/12

(52) U.S. Cl. CPC B60W 50/12; B60W 2300/156; B60W 2554/4041

(57) ABSTRACT

A ground working vehicle having one or more operating parameters is disclosed. Each geographical location in which the ground working vehicle operates may have associated therewith a specific value for the one or more operating parameters. Therefore, when the ground working vehicle is located within an established geographical location, the specific value for the one or more operating parameters at that geographical location is provided to the ground working vehicle. The ground working vehicle may accept the specific value by, for example, automatically adjusting, prompting the operator, notifying the operator, disengaging the vehicle if the current value is not within the specific value, etc.

The present application claims priority to and/or the benefit of U.S. Provisional Patent Application No. 63/434,410, filed 21 Dec. 2022, which is incorporated herein by reference in its entirety.

Embodiments of the present disclosure are directed to ground working vehicles such as stand-on or walk-behind lawn mowers and, more particularly, to such vehicles incorporating adjustable operating parameters.

### BACKGROUND

Riding and walk-behind ground working vehicles such as lawn mowers, aerators, spreaders/sprayers, and the like are used by homeowners and professionals alike to care for lawns and other surfaces. These vehicles typically include a prime mover, e.g., internal combustion engine or electric motor, to power not only an implement (e.g., cutting deck) attached to the vehicle, but also a traction drive system, the latter adapted to propel the vehicle over a ground surface.

The implement of the vehicle may be secured to a frame of the vehicle and the position of which may be adjustable relative to the frame and the ground surface. Some designs provide for manual adjustment of the position of the implement relative to the vehicle frame such as by a manually-adjustable position fastener associated with the implement that abuts the frame to set the desired position. The implement's weight exerts a force on the position fastener to, at least in part, secure the connection. In addition to adjusting the position of the implement, it can also be desirable to adjust other operating parameters of the vehicle.

### SUMMARY

Embodiments of the present disclosure may provide a method including storing a plurality of geographical locations in a database and providing a specific value for one or more operating parameters of a ground working vehicle for each geographical location of the plurality of geographical locations. The method may also include comparing a current geographical location of the ground working vehicle to the plurality of geographical locations and interacting with the ground working vehicle based on the specific value for the one or more operating parameters of a geographical location when the ground working vehicle is located within the geographical location.

In another embodiment, a method is provided that includes storing a plurality of geographical locations in a database, wherein each geographical location included in the plurality of geographical locations comprising an area. The method further includes: providing a specific value for at least one operating parameter of a ground working vehicle for each geographical location included in the plurality of geographical locations in the database; and determining that a current geographical location of the ground working vehicle corresponds to one of the geographical locations included in the plurality of geographical locations in the database based on the plurality of geographical locations in the database and the current geographical location of the ground working vehicle. In response to determining that the current geographical location of the ground working vehicle corresponds to the one of the geographical locations included in the plurality of geographical locations in the database, the method further includes controlling operation of the ground working vehicle based on the specific value for the at least one operating parameter for the current geographical location.

In yet another embodiment, a ground working vehicle is provided that includes: one or more actuators configured to control one or more operating parameters associated with the ground working vehicle; and one or more controllers coupled to the one or more actuators. The controllers are configured to determine that a current geographical location of the ground working vehicle corresponds to a geographical location included in a plurality of geographical locations stored in a database based on the plurality of geographical locations in the database and the current geographical location of the ground working vehicle, wherein each geographical location included in the plurality of geographical locations comprises an area and corresponds with a specific value for each of the one or more operating parameters. In response to determining that the current geographical location of the ground working vehicle corresponds to the geographical location included in the plurality of geographical locations stored in the database, the controllers are configured to control operation of the ground working vehicle based on the specific value for each of the one or more operating parameters.

In still another embodiment, a ground working vehicle system is provided that includes: a ground working vehicle having an actuator configured to control an operating parameter associated with the ground working vehicle; and a controller operatively coupled to the actuator; and a database. The database includes: a plurality of geographical locations, each geographical location included in the plurality of geographical locations comprising an area; and a specific value for the operating parameter associated with the ground working vehicle for each geographical location included in the plurality of geographical locations. The controller is configured to determine that a current geographical location of the ground working vehicle corresponds to one of the geographical locations included in the plurality of geographical locations in the database based on the plurality of geographical locations in the database and the current geographical location of the ground working vehicle. In response to determining that the current geographical location of the ground working vehicle corresponds to the one of the geographical locations included in the plurality of geographical locations in the database, the controller is further configured to control operation of the ground working vehicle based on the specific value for the operating parameter.

The above summary is not intended to describe each embodiment or every implementation. Rather, a more complete understanding of illustrative embodiments will become apparent and appreciated by reference to the following Detailed Description of Exemplary Embodiments and claims in view of the accompanying figures of the drawing.

### BRIEF DESCRIPTION OF THE VIEWS OF THE DRAWING

Exemplary embodiments will be further described with reference to the figures of the drawing, wherein:

FIG. 1 is a right rear perspective view of a ground working vehicle, e.g., a stand-on mower, with one or more adjustable operating parameters in accordance with embodiments of the present disclosure;

FIG. 2A is a flow diagram of an exemplary method of setting a specific value of one or more operating parameters when a vehicle is within a geographical location;

FIG. 2B is a flow diagram of another exemplary method of controlling operation of a vehicle based on a specific value of one or more operating parameters when the vehicle is within a geographical location;

FIG. 3 is a schematic representation of communications between a user, a database, and a vehicle as it pertains to one or more operating parameters associated with a geographical location;

FIG. 4 is a schematic representation of a plurality of geographical locations; and

FIG. 5 is a schematic representation illustrating an enlarged virtual boundary surrounding a geographical location.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

### DETAILED DESCRIPTION OF EXEMPLARY EMBODIMENTS

In the following detailed description of illustrative embodiments, reference is made to the accompanying figures of the drawing which form a part hereof. It is to be understood that other embodiments, which may not be described and/or illustrated herein, are certainly contemplated.

All headings provided herein are for the convenience of the reader and should not be used to limit the meaning of any text that follows the heading, unless so specified. Moreover, unless otherwise indicated, all numbers expressing quantities, and all terms expressing direction/orientation (e.g., vertical, horizontal, parallel, perpendicular, etc.) in the specification and claims are to be understood as being modified in all instances by the term “about.” Furthermore, the terms “having,” “including,” “comprises” and variations thereof do not have a limiting meaning where these terms appear in this description and claims, and the terms “a,” “an,” “the,” “at least one,” and “one or more” are used interchangeably herein. The term “and/or” (if used) means one or all of the listed elements or a combination of any two or more of the listed elements. “I.e.” is used as an abbreviation for the Latin phrase id est and means “that is.” “E.g.” is used as an abbreviation for Latin phrase exempli gratia and means “for example.”

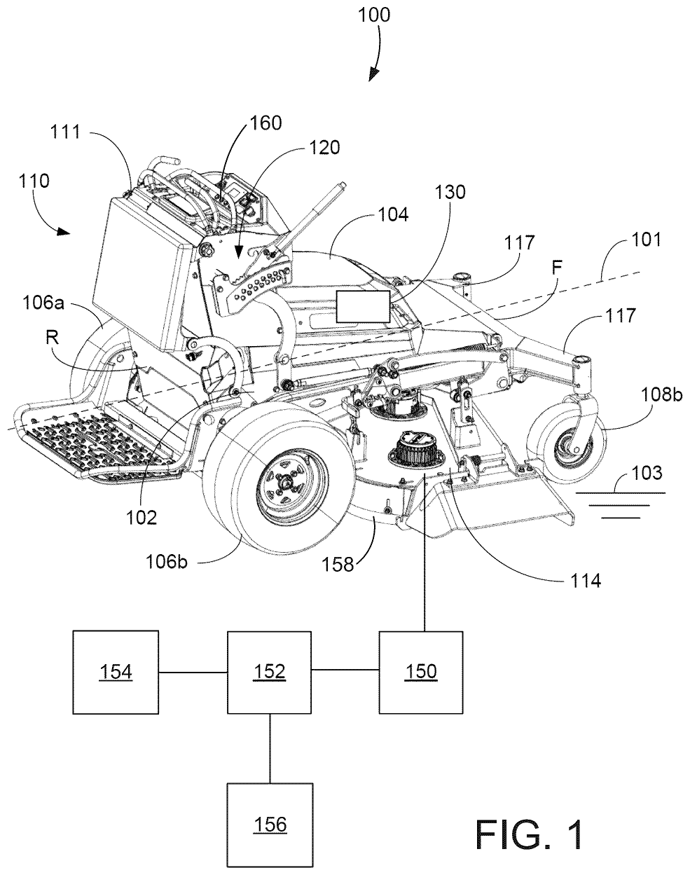

Still further, relative terms such as “left,” “right,” “front,” “fore,” “forward,” “rear,” “aft,” “rearward,” “top,” “bottom,” “side,” “upper,” “lower,” “above,” “below,” “horizontal,” “vertical,” and the like may be used herein and, if so, are from the perspective of one operating a vehicle (e.g., vehicle 100) while the vehicle is in an operating configuration, e.g., while it is positioned such that ground engaging members (e.g., wheels) rest upon a generally horizontal ground surface 103 as shown in FIG. 1. These terms are used only to simplify the description, however, and not to limit the interpretation of any embodiment described.

Embodiments described and illustrated herein are directed to powered (e.g., self-propelled) ground working vehicles (e.g., a grounds maintenance vehicle) incorporating an implement (e.g., a cutting deck) that may be adjusted as desired. For example, the implement or other components of the vehicle may be adjusted in various ways as desired by an operator or other individual. In other words, the vehicle may include one or more operating parameters that are adjustable by the operator. The one or more operating parameters may include: a vehicle speed; a height of the implement relative to the ground surface (e.g., a height-of-cut of the cutting deck); rake angle (e.g., fore-and-aft (or side-to-side) tilt of the implement (the angle at which the implement lies relative to the ground surface)); a position of a baffle of the implement (e.g., an implement baffle or a kick-down ramp baffle associated with a cutting deck); a treating material (e.g., granular, liquid, or chemical) application rate of the implement, an implement rate (e.g., speed or depth of an aerating tine), a spacing of the implement (e.g., aeration tine (e.g., hole) spacing), and/or snow removal parameters (e.g., auger and/or impeller speed of a snow thrower implement), etc.

Further, each of the one or more operating parameters may be set to a specific (e.g., desired) value or setting (e.g., a preference). In one or more embodiments, a specific value or setting for the one or more operating parameters may be based on a geographical location (e.g., a customer site) of the vehicle. In other words, depending on the geographical location of the vehicle, it may be desirable for the vehicle to have a specific value for the one or more operating parameters (e.g., as requested by the property owner). Therefore, once the vehicle is located within a geographical location (e.g., from a database of established geographical locations), the vehicle may be set to the specific value for the one or more operating parameters.

The vehicle may be set to the specific value for the one or more operating parameters (e.g., when within the geographical location) in a variety of different ways. For example, in one or more embodiments, the specific value for the one or more operating parameters may be automatically set when the vehicle is within the geographical location, the vehicle may alert or advise an operator (e.g., by sending a message) about the specific value for the one or more operating parameters (e.g., with the operator setting the specific value in response), the vehicle may be disengaged (e.g., disable the implement or disable power to the implement) if a current value for the one or more operating parameters is not within the specific value (e.g., for the geographical location), the operator of the vehicle may be prompted to engage a button to modify the one or more operating parameters to the specific value (e.g., for the geographical location), etc.

A plurality of geographical locations may be stored in a database (e.g., database stored onboard the vehicle, or an internet- or cloud-based database) and used as a reference to compare to the current geographical location of the vehicle. In one or more embodiments, the current geographical location of the vehicle may be determined using a vehicle tracking device. In other words, the vehicle tracking device may be coupled to the vehicle so that the current geographical location of the vehicle may be compared to the plurality of geographical locations. In some embodiments, the current geographical location can be and/or include coordinate values. For example, the coordinate values can be Global Navigation Satellite System (GNSS) coordinate values (e.g., Global Positioning System (GPS) coordinate values). In some embodiments, the current geographical location can be and/or include an area demarcated by a real or virtual boundary. For example, the area can be an area extending radially from estimated coordinate values (e.g., a circular area having a radius and an origin at estimated coordinate values). In some embodiments, the current geographical location can include both coordinate values and an area. In these embodiments, the coordinate values may be used as an estimated location of the vehicle and the area may be used as a safety buffer to ensure proper operation of the vehicle. Further, the specific values of the one or more operating parameters for each geographical location may also be stored in the database.

With reference to the figures of the drawing, wherein like reference numerals designate like parts and assemblies throughout the several views, FIG. 1 illustrates a self-propelled vehicle 100, e.g., a mid-mount lawn mower, including an implement 114 (e.g., cutting deck) and various adjustable operating parameters. While, for the sake of brevity, embodiments of the disclosure are herein described with reference to a mid-mount stand-on mower (hereinafter generically referred to simply as a “mower”), those of skill in the art will realize that the concepts described herein are equally applicable to other types of walk-behind and stand-on vehicles including an implement, as well as to almost any other walk-behind, stand-on, or sit-on ground working vehicle having an implement.

It is noted that the suffixes “a” and “b” may be used throughout this description to denote various left- and right-side parts/features of the vehicle, respectively. However, in most pertinent respects, the parts/features denoted with “a” and “b” suffixes are substantially identical to, or mirror images of, one another. It is understood that, unless otherwise noted, the description of an individual part/feature (e.g., part/feature identified with an “a” suffix) also applies to the opposing part/feature (e.g., part/feature identified with a “b” suffix). Similarly, the description of a part/feature identified with no suffix may apply, unless noted otherwise, to both the corresponding left and right part/feature.

While not necessarily central to an understanding of exemplary embodiments of the present disclosure (e.g., other mower and other vehicle configurations are certainly contemplated), the general construction of the illustrative vehicle 100 (e.g., mower) is briefly described below. FIG. 1 illustrates the vehicle 100 including a frame or chassis 102 having a front end F and a rear end R (and a longitudinal axis 101 extending between the front and rear ends), the chassis 102 supporting a power source or prime mover 104, e.g., internal combustion engine or battery pack for powering electric motor(s). A pair of transversely opposing, ground engaging members, e.g., first and second (left and right) rear drive wheels 106a and 106b, may be coupled to opposite (left and right) rear sides of the chassis 102 to support the mower upon, and propel the vehicle 100 relative to, the ground surface 103. Each drive wheel 106 may be powered by an electric motor or its own hydraulic motor that receives power from, at least in one embodiment, its own hydrostatic pump. Other drive systems, e.g., gear or pulley driven systems, may also be utilized by the vehicle 100.

Operator controls, as further described below, permit independent control of the speed and direction of each drive wheel 106, allowing operator control of vehicle 100 speed and direction from a walking or riding (e.g., standing) position generally behind the vehicle 100. A pair of front ground engaging members (e.g., left and right caster wheels 108 (only right wheel 108b shown in FIG. 1), which may be connected to forwardly extending frame rails 117, may support the front of the vehicle 100 in rolling engagement with the ground surface 103.

Although the illustrated vehicle 100 has the drive wheels 106 in the rear and caster wheels 108 in front, this configuration is not limiting. For example, other embodiments may reverse the location of the wheels, e.g., drive wheels in front and driven or undriven wheels in back. Moreover, other configurations may use different wheel configurations altogether, e.g., a tri-wheel configuration or a vehicle having conventionally-steered wheels. These and other embodiments are certainly possible without departing from the scope of the present disclosure. Moreover, while illustrated herein as wheels, other ground engaging members (e.g., tracks, skids, rollers, etc.) are also contemplated.

An implement 114, e.g., cutting deck, may be connected to a lower side of the chassis 102 (generally longitudinally between the drive wheels 106 and the caster wheels 108). The implement 114 (e.g., a cutting deck) may include one or more cutting blades as known in the art. The cutting blades may be operatively powered, via spindles connected to the implement 114, by the prime mover 104 via, e.g., an implement drive system. During operation, power may be selectively delivered to the implement 114, whereby the blades rotate at a speed sufficient to sever grass and other vegetation as the implement 114 passes over the ground surface 103. As indicated above, other ground working vehicles 100 may locate the implement 114 above the chassis, or at other locations along the lower side of the chassis 102 (e.g., a forwardly-mounted or “out-front” deck configuration). In some embodiments, the implement 114 may include a baffle 158 that assists with implement operation. For example, with a cutting deck, the baffle may be located along a rear sidewall of the deck. The baffle may be vertically adjustable to improve deck performance. While shown as a sidewall baffle, internal baffles, which may also be adjustable, are also contemplated. Moreover, while illustrated as a cutting deck, the implement 114 may be any tool (e.g., aerator, spreader, sprayer, etc.) that attaches to the chassis 102. For example, while FIG. 1 illustrates the vehicle 100 as a mower, any suitable ground working vehicle is contemplated herein such as, e.g., aerator, spreader/sprayer, debris management system, blower, vacuum, sweeper, snowthrower, or other (indoor or outdoor) working vehicle.

The vehicle 100 may further include an operator control system 110. In the illustrated embodiment, the control system 110 may include operator controls that are mounted to upwardly extending portions of the chassis referred to herein as control tower 111. The control tower 111 may be located at or near the rear end R of the vehicle 100. Situated near the top of the control tower 111 is a control area that positions mower controls within comfortable reach of an operator who may be standing either upon a platform or behind the mower (e.g., when the platform is stowed vertically). The control system 110 may include control levers configured to move the vehicle 100 forward and rearward. The control system 110 may also include a parking brake handle to selectively activate a brake when the vehicle is parked. A deck height selection tool 120 may also be provided to adjust the cutting height of the implement 114 (e.g., height-of-cut). Other controls may include a throttle lever to control the speed of the engine 104, an implement clutch control (e.g., to initiate and terminate power delivery to the cutting blades of the implement 114), an implement angle control, a baffle angle or position control, etc.

These adjustable components of the vehicle 100 may be described as one or more operating parameters. Each of the one or more operating parameters may be set to a specific value as desired. Further, as described herein, the vehicle may have a specific value for the one or more operating parameters depending on a geographical location of the vehicle (e.g., a customer preference for the customer property or site). For example, a property owner may request than their lawn is cut to a specific height-of-cut (e.g., a specific value for one or more operating parameters) and if a lawn mower is located within that property (e.g., a geographical location), the lawn mower (e.g., owned and operated by a commercial business) may be set (e.g., using various methods described herein) to the specific height-of-cut in accordance with the present disclosure.

The apparatuses used to control the one or more operating parameters may be mechanical or electronic. For example, in one or more embodiments, the apparatuses may include various elements or features that can be manually manipulated to adjust the one or more operating parameters. Also, for example, in one or more embodiments, the one or more operating parameters may be remotely controlled. In other words, the one or more operating parameters may be adjusted without being manually and physically adjusted by an operator. For example, in one or more embodiments, the vehicle 100 may include one or more actuators 150 (e.g., as shown schematically in FIG. 1) operatively coupled to the apparatuses used to control the one or more operating parameters. The one or more actuators 150 may be configured to adjust the one or more operating parameters. Further, the one or more actuators 150 may include any suitable components that adjust the one or more operating parameters such as, e.g., linear actuators, rotary actuators, hydraulic actuators, pneumatic actuators, electric actuators, etc.

The vehicle 100 may also include one or more controllers 152 operatively coupled to the one or more actuators 150 (e.g., as shown schematically in FIG. 1). Further, the one or more controllers 152 may be configured to instruct the one or more actuators 150 to adjust the one or more operating parameters. For example, in one or more embodiments, the one or more controllers 152 may be configured to allow an operator to directly adjust the one or more operating parameters via the one or more actuators 150. In other embodiments, the one or more controllers 152 may be configured to automatically adjust the one or more operating parameters via the one or more actuators 150. As such, the one or more controllers 152 may be aware of the position or setting (e.g., using sensors, etc.) of the one or more operating parameters and the amount to which the one or more operating parameters are being adjusted.

In some embodiments, the one or more controllers 152 can include and/or be coupled to one or more interface elements 154. Each interface element included in the one or more interface elements 154 can receive input from a user to adjust a value of an operating parameter. For example, the one or more interface elements 154 can include one or more buttons, levers, switches, knobs, dials, joysticks, pedals, triggers, twistgrips, touchscreens, or other suitable interface elements capable of receiving input from the user. The user may actuate and/or interact with one or more of the interface elements 154 to provide input data to the one or more controllers 152. The input data can include one or more adjustments to one or more current values of the operating parameters. For example, the user may twist a knob to adjust a current value of a vehicle speed of the vehicle 100. As another example, the user may actuate a lever to adjust a value of a height-of-cut of the vehicle 100.

In some embodiments, the one or more controllers 152 can be configured to receive input data from the one or more interface elements 154 and actuate the one or more actuators 150 based in the input data. For example, the one or more controllers 152 can receive input data from a dial included in the one or more interface elements 154 and adjust a height-of-cut of the implement based on the input data from the dial. As another example, the one or more controllers 152 can receive input data from a button included in the one or more interface elements 154 and adjust a vehicle speed of the vehicle 100 based on the input data from the button. In some embodiments, the one or more controllers 152 can, in response to a user actuating a button included in the one or more interface elements 154, automatically adjust one or more values of operating parameters based on one or more specific values. For example, the one or more controllers 152 can, in response to the user actuating the button included in the one or more interface elements 154, automatically adjust one or more values of operating parameters to be equal to the corresponding specific values.

In some embodiments, the one or more controllers 152 can include and/or be coupled to one or more displays 156. The one or more displays 156 can include liquid crystal display (LCD) screens, light emitting diode (LED) screens, organic light emitting diode (OLED) screens, seven-segment displays, and/or other suitable displays. In some embodiments, the one or more controllers 152 can cause a notification, alert, and/or warning to be displayed at the one or more displays 156 regarding one or more operating parameters. For example, the notification, alert, and/or warning can indicate a specific value for an operating parameter. As another example, the notification, alert, and/or warning can indicate that a current value of an operating parameter needs to be adjusted to meet a specific value (e.g., a specific height-of-cut value). In this way, the one or more controllers 152 can notify, alert, and/or warn the user of the vehicle 100 about the specific value and prompt the user to modify current values of one or more operating parameters. In some embodiments, the one or more displays 156 may persistently display a specific value for one or more operating parameters. In this way, the one or more controllers 152 can continuously inform the user of the vehicle 100 of the specific value for one or more operating parameters.

The vehicle 100 can include each of the one or more actuators 150, the one or more controllers 152, the one or more interface elements 154, and the one or more displays 156. In some embodiments, the one or more interface elements 154 and/or the one or more displays 156 can be coupled to and/or included in the control tower 111. For example, at least one button 160 can be coupled to and/or included in the control tower 111.

The exemplary controller may include a processor that receives various inputs and executes one or more computer programs or applications stored in memory. The memory may include computer-readable instructions or applications that, when executed, e.g., by the processor, cause the controller to perform various calculations and/or issue commands. That is to say, the processor and memory may together define a computing apparatus operable to process input data and generate the desired output to one or more components/devices.

In view of the above, it will be readily apparent that the functionality of the controller may be implemented in any manner known to one skilled in the art. For instance, the memory may include any volatile, non-volatile, magnetic, optical, and/or electrical media, such as a random-access memory (RAM), read-only memory (ROM), non-volatile RAM (NVRAM), electrically-erasable programmable ROM (EEPROM), flash memory, and/or any other digital media. While the memory and processor may be incorporated into the controller, the memory and the processor could be contained in separate modules.

The processor may include any one or more of a microprocessor, a controller, a digital signal processor (DSP), an application specific integrated circuit (ASIC), a field-programmable gate array (FPGA), and/or equivalent discrete or integrated logic circuitry. In some embodiments, the processor may include multiple components, such as any combination of one or more microprocessors, one or more controllers, one or more DSPs, one or more ASICs, and/or one or more FPGAs, as well as other discrete or integrated logic circuitry. The functions attributed to the controller/processor herein may be embodied as software, firmware, hardware, or any combination thereof.

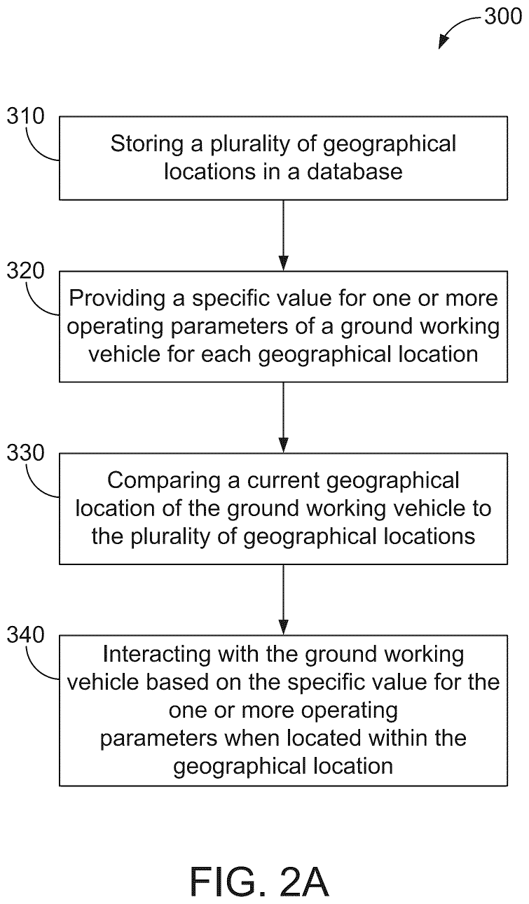

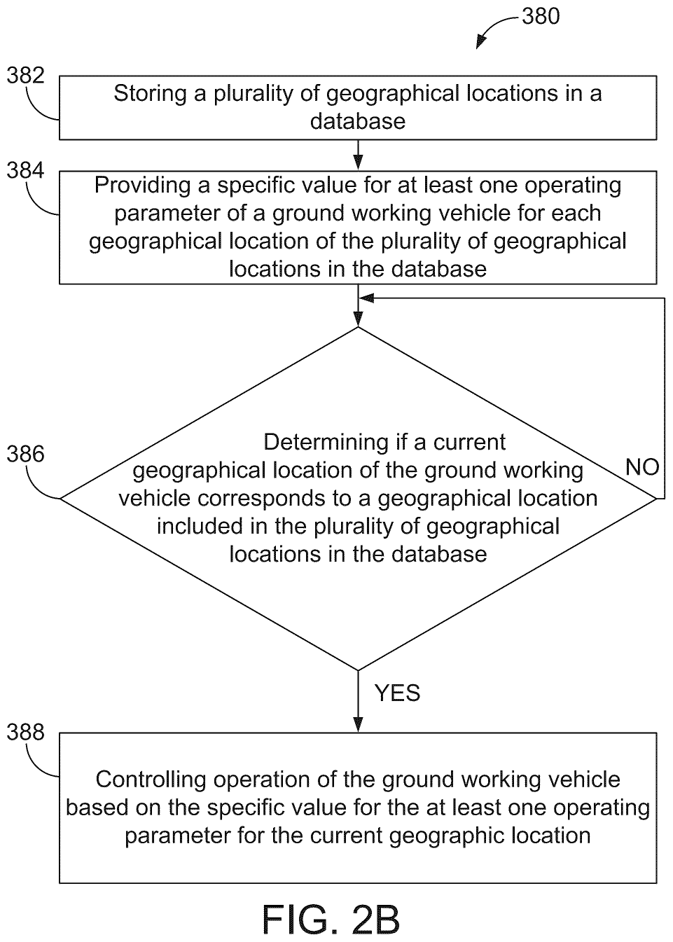

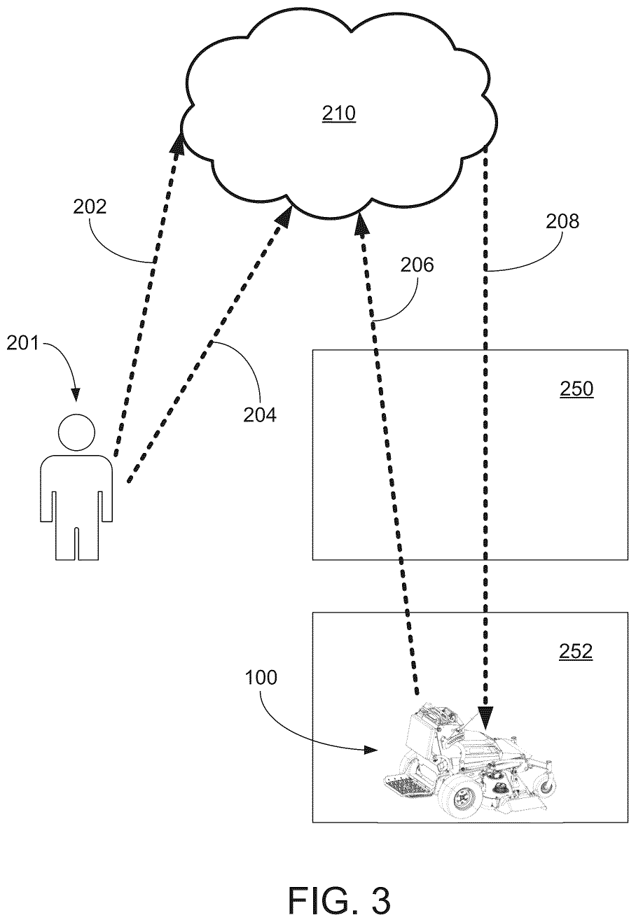

A method 300 of setting a specific value of one or more operating parameters when a vehicle is within a geographical location is illustrated in FIG. 2A as a flow diagram. The method 300 may include storing 310 a plurality of geographical locations in a database. For example, as shown in FIG. 3, a user or operator 201 may identify a geographical location and store 202 the geographical location in the database 210. The database 210 may include any internet or network connected database that can be accessed remotely, including databases stored onboard the vehicle.

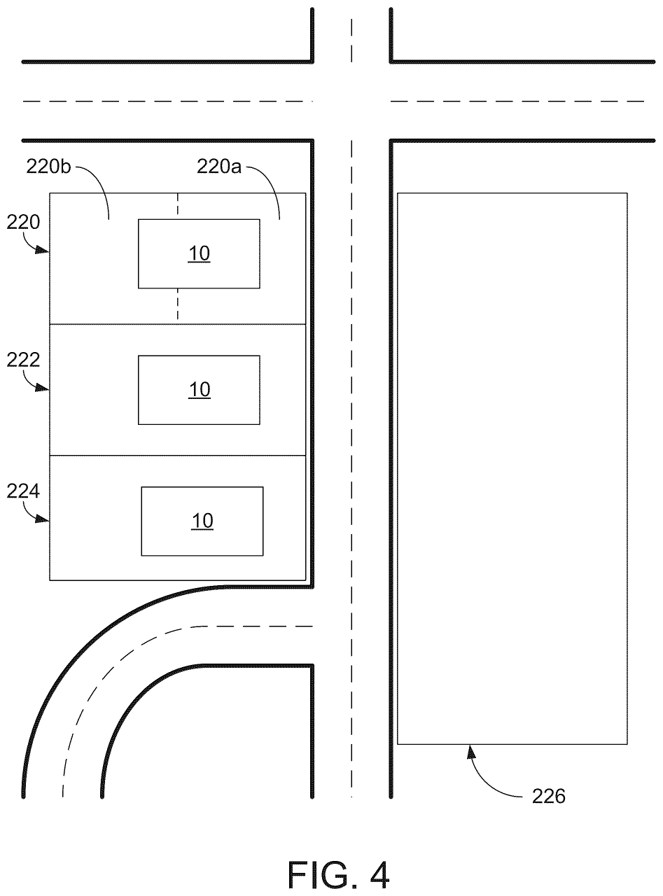

The geographical location may be any place in which a ground working vehicle as described herein may operate. For example, in one or more embodiments, the geographical locations may include customer sites upon which a commercial business operates ground working vehicles (e.g., mowers). As shown in FIG. 4, the geographical locations may include different types of properties geographically spaced apart or otherwise distinctly delineated. Specifically, FIG. 4 illustrates three geographical locations (properties) 220, 222, 224 (e.g., residential properties) including a house 10 on each property. Also, FIG. 4 illustrates another property 226 that may be a different size and may be, e.g., a park or industrial area. The plurality of geographical locations may include, for example, each of properties 220, 222, 224, 226 illustrated in FIG. 4 as well as other properties that may or may not be located in close proximity thereto. While shown herein as having distinct and separate boundaries, two or more of the geographical locations could overlap one another without departing from the scope of this disclosure.

A user (e.g., a customer, an operator, a servicer, an engineer, a supervisor, etc.) may use a controller to establish each geographical location by defining the boundaries (e.g., a geofence) of each geographical locations. Each geographical location can include an area demarcated by at least one boundary. In some embodiments, the area can be demarcated by a single continuous boundary. For example, a rectangular area may be demarcated by a geofence having four approximately straight boundary portions forming a single continuous boundary. The boundary of each geographical location of the plurality of geographical locations may be determined or established in a variety of different ways. For example, in one or more embodiments, the boundary of a geographical location may be determined using GNSS, a property address (e.g., using geo-spatial data), or an electronic map (e.g., using GOOGLE MAPS overlay). Specifically, the boundary may be outlined using one of the above methods and compared to the actual location of the vehicle using a vehicle tracking device (e.g., a low powered vehicle tracking device) coupled to the vehicle (e.g., via GNSS). In one or more embodiments, the geographical location may include sensors or wireless equipment to communicate with the vehicle regarding the current location. It is noted that, in one or more embodiments, the boundary may be defined as a geofence placed around the geographical location.

Furthermore, the granularity of the boundary of each geographical location may be limited by the technology used to define the boundary. For example, in one or more embodiments, an electronic map and satellite technology (e.g., GNSS) may identify the boundary of the geographical location within about a five foot radius. However, because the geographical location is used to assist in modifying a specific value for one or more operating parameters, this granularity may be sufficient. As shown in FIG. 4, the three properties 220, 222, 224 are separated from property 226 by a road. Therefore, the delineation between three properties 220, 222, 224 and the property 226 may be clearer than the delineation between the three properties 220, 222, 224. As it pertains to properties 220, 222, 224 that are next to one another, the geographical locations share a boundary. However, even though each property may define different specific values for the one or more operating parameters, the operator of the vehicle can maintain a clean boundary between properties because the vehicle drives independent of the established geographical location. In other words, the system may suggest a different specific value for the one or more operating parameters (e.g., a height-of-cut) when close to the boundary but does not affect the driving of the vehicle.

Referring again to FIG. 2A, the method 300 may also include providing at 320 a specific value for one or more operating parameters of a ground working vehicle for each geographical location of the plurality of geographical locations. For example, once a geographical location is stored within the database, a specific value for one or more operating parameters may also be stored to the database and connected to the corresponding geographical location. As shown in FIG. 3, the user 201 may associate or connect a specific value 204 of an operating parameter to a geographical location and store the specific value (and the connection to the geographical location) in the database 210. For example, in one or more embodiments, a user may identify that a specific property prefers or requests that the grass be cut to a height-of-cut of 2 inches and, therefore, a 2 inch height-of-cut at that property may be stored in the database 210. In one or more embodiments, the specific values for the one or more operating parameters at a geographical location may be determined based on historical data (e.g., the specific value may be input into the system after a first passthrough at the geographical location).

The one or more operating parameters may include any suitable characteristic for a ground working vehicle and be unique to the ground working vehicle. Also, as stated above, the one or more operating parameters may be connected to a geographical location. For example, in one or more embodiments, an owner or someone associated with a property may have indicated a preference for one or more operating parameters of the ground working vehicle at the property, e.g., the height-of-cut and ground speed for the property. Specifically, in at least one example, the preference may include that the height-of-cut for grass at the property to be 2 inches and the ground speed of the vehicle at the property to be 5 miles per hour.

As stated above, the one or more operating parameters may include: a vehicle speed; a height of the implement relative to the ground surface (e.g., a height-of-cut of the cutting deck); rake angle (e.g., fore-and-aft (or side-to-side) tilt of the implement relative to the ground surface (the angle at which the implement lies relative to the ground surface)); a position of a baffle of the implement (e.g., an implement baffle or a kick-down ramp baffle associated with a cutting deck implement); a treating material (e.g., granular, liquid, or chemical) application rate of the implement; an implement rate (e.g., speed or depth of an aerating tine); a spacing of the implement (e.g., aeration tine (e.g., hole) spacing); and snow removal parameters (e.g., auger and/or impeller speed of a snow thrower implement), etc.

In other embodiments, the one or more operating parameters may include one or more limits such as vehicle speed limit, height-of-cut limit, rake angle limit, baffle position limit, treating material application rate limit, implement rate limit, implement spacing limit, etc.

Additionally, each of the properties may be grouped together or further divided. For example, the properties 220, 222, 224 illustrated in FIG. 4 may be grouped together due to sharing specific values for one or more operating parameters within the property. In one or more embodiments, the geographical location defined by the collection of properties 220, 222, 224 may include grass to be cut to a height-of-cut of 2.5 inches. Also, for example, a property may be divided due to differing specific values for one or more operating parameters within the property. As shown in FIG. 4, property 220 may be divided into front yard 220a and back yard 220b. For example, property 220 may be divided because the front yard 220a may include grass to be cut to a height-of-cut of 2 inches and the back yard 220b may include grass to be cut to a height-of-cut of 3 inches.

The method 300 may also include comparing at 330 a current geographical location of the ground working vehicle to the plurality of geographical locations, as shown in FIG. 2A. For example, the vehicle 100 may send a transmission 206 to the database 210 regarding the current geographical location of the vehicle 100, e.g., as shown in FIG. 3. The vehicle may include any suitable device for geolocating the vehicle 100 (e.g., a vehicle tracking device). For example, the vehicle may include a device that determines location using a GNSS receiver. For example, a GNSS may be used to tie a three-dimensional point cloud (3DPC) to a real-world mapping service, such as GOOGLE MAPS. Specifically, the device may include a vehicle tracking device such as, e.g., a CalAmp device produced by CalAmp of Irvine, California. The vehicle tracking device may be configured to estimate a position of the vehicle 100.

The vehicle tracking device 130 (e.g., represented schematically in FIG. 1) may be coupled to the vehicle 100 to track the current geographical location of the vehicle 100. The vehicle tracking device 130 may be located at any suitable position on the vehicle 100.

The current geographical location of the vehicle may be compared to the plurality of geographical locations stored in the database. For example, as shown in FIG. 3, there are two geographical locations 250, 252. Further, for example, the vehicle 100 may transmit a current geographical location (e.g., via the vehicle tracking device) that corresponds with geographical location 252. Thereafter, a specific value for the one or more operating parameters that are associated with the geographical location (e.g., geographical location 252 within which the vehicle is located) may be determined.

Referring back to FIG. 2A, the method 300 may also include interacting at 340 with the ground working vehicle based on the specific value for the one or more operating parameters of a geographical location when the ground working vehicle is located within the geographical location. For example, as shown in FIG. 3, the specific value 208 may be transmitted from the database 210 to the vehicle 100. After the specific value is transmitted to the vehicle 100, the vehicle 100 may utilize the information in a variety of different ways. For example, an operator of the vehicle may be notified or alerted or advised of the specific value, the vehicle may be disengaged if not set to the correct specific value, the one or more operating parameters of the vehicle may be automatically adjusted, the operator may be prompted to change the one or more operating parameters to the specific value upon pressing a button, etc.

In one or more embodiments, the ground working vehicle may alert or notify or advise an operator (e.g., of the ground working vehicle) about the specific value for the one or more operating parameters of the geographical location. Specifically, the ground working vehicle may include a display (e.g., the one or more displays 156 in FIG. 1) to show the operator the specific value for the one or more operating parameters. Therefore, the display may notify the operator of the specific value such that the operator may adjust (e.g., mechanically or electronically) the one or more operating parameters of the vehicle to the specific value. In one specific example, when a mower is confirmed to be located within a customer site, an operator of the mower may be alerted or notified that the particular customer site should have the grass cut to a specific height-of-cut and the operator should adjust the mower accordingly.

In one or more embodiments, the current value for the one or more operating parameters may be compared to the specific (desired) value for the one or more operating parameters at the geographical location (e.g., within which the vehicle is located). If the current value for the one or more operating parameters is within the specific value for the geographical location (e.g., equal to or within a range), the vehicle will continue to function as normal. But if the current value for the one or more operating parameters is not within the specific value for the geographical location, the vehicle may be disengaged. For example, the vehicle may be disengaged by turning off the vehicle or disabling the power takeoff (e.g., preventing the implement or tool from activating).

In one or more embodiments, the current value for the one or more operating parameters of the vehicle may be measured. Thereafter, the current value may be compared to the desired or specific value. Therefore, the vehicle may include a device (e.g., a potentiometer, a sensor, etc.) to measure the current value for the one or more operating parameters. In one specific example, the current height-of-cut setting for the mower may be measured and compared to the desired or specific height-of-cut setting for a customer site. If the current height-of-cut is equal to the desired or specific height-of-cut for the customer site, the mower continues to operate as configured, but if the current height-of-cut is not equal to the desired or specific height-of-cut for the customer site, the cutting blade may be prevented from rotating. In other words, the mower may need to have the correct height-of-cut (e.g., that is associated with the customer site) set in order for the mower to operate properly.

In one or more embodiments, the ground working vehicle may be automatically set to the specific value for the one or more operating parameters of the geographical location when the vehicle is within the geographical location. As discussed below, a stored value included in the vehicle (e.g., in a memory of the vehicle) may be set to the specific value for the one or more operating parameters. For example, the vehicle may include a controller and actuator (e.g., as described herein) to automatically adjust the one or more operating parameters of the vehicle to the specific value. In such embodiments, the vehicle may also include a device (e.g., a potentiometer, a sensor, etc.) to measure the current value for the one or more operating parameters to ensure that the one or more operating parameters of the vehicle are correctly set automatically. In one specific example, once it is determined that the mower is located within a customer site, the height-of-cut of the mower is automatically adjusted to the desired or specific height-of-cut.

In one or more embodiments, the ground working vehicle may prompt the operator to engage a button (e.g., a button included in the one or more interface elements 154) operably connected to the one or more operating parameters and configured to modify the one or more operating parameters to the specific value upon engaging the button. For example, when the ground working vehicle is within a geographical location, the operator may be prompted regarding the specific value for one or more operating parameters at that geographical location. Thereafter, the operator may engage a button that adjusts the one or more operating parameters to the specific value (e.g., through the one or more actuators described herein). In such embodiments, the vehicle may also include a device (e.g., a potentiometer, a sensor, etc.) to measure the current value for the one or more operating parameters. In one specific example, once it is determined that the mower is located within a customer site, the operator is prompted to engage a button to adjust the height-of-cut to the desired or specific height. The button may be operatively coupled to a controller (e.g., the one or more controllers 152) and an actuator (e.g., the one or more actuators 150) to adjust the one or more operating parameters.

In one or more embodiments, the specific value for the one or more operating parameters may be based on an operator of the ground working vehicle. For example, depending on which operator is using the vehicle, the vehicle may be set to a different value for the one or more operating parameters (e.g., using the processes described herein). The vehicle may identify the operator in any suitable way including unique operator information such as, for example, Personal Identification Number (PIN) code, Radio Frequency Identification (RFID), etc. In such embodiments, the vehicle may include a receiver for the operator to input the unique operator information.

In addition to being associated with a current value and a specific value, the operating parameter may, in some embodiments, be associated with a stored value used to control operation of the vehicle. The stored value can be a primary value that the vehicle follows during operation. The vehicle can set an operating parameter to be equal to a specific value by setting a stored value associated with the operating parameter equal to the specific value. In some embodiments, the stored value can be changed, modified, or controlled by an operator of the vehicle. In some embodiments, the stored value can be automatically changed, modified, or controlled by a controller coupled to the vehicle. To modify an operating parameter, the method 300 can include modifying the stored value associated with the operating parameter.

In one or more embodiments, the process described herein may be applied to certain aspects of snow removal or chemical application. For example, the processes described herein may be modified such that the geographical location for which snow removal occurred or chemicals were applied may be recorded. In other words, in addition to the geographical location being associated with a specific value for one or more operating parameters (e.g., chemical application rate), the presence of the vehicle within the geographical location may be tracked and recorded. Further, the actual application rate and time/frequency of the vehicle within the geographical location may be tracked and recorded. Therefore, the completion of a particular job and operating parameters used therein may be proved (e.g., to a customer).

Another exemplary method 380 of controlling operation of a vehicle based on a specific value of one or more operating parameters when the vehicle is within a geographical location is illustrated in FIG. 2B as a flow diagram. The method 380 may include storing at 382 a plurality of geographical locations in a database. In some embodiments, at least a portion of storing a plurality of geographical locations in a database can be the same or similar to the storing a plurality of geographical locations in a database at 310 in FIG. 2A. Each geographical location included in the plurality of geographical locations can include an area. Each area can be demarcated by at least one boundary.

The method 380 may also include providing at 384 a specific value for at least one operating parameter of a ground working vehicle for each geographical location of the plurality of geographical locations. In some embodiments, at least a portion of providing a specific value for at least one operating parameter of a ground working vehicle for each geographical location of the plurality of geographical locations can be the same or similar to providing a specific value for one or more operating parameters of a ground working vehicle for each geographical location of the plurality of geographical locations at 320 in FIG. 2A.

The method 380 may also include determining at 386 if a current geographical location of the ground working vehicle corresponds to a geographical location included in the plurality of geographical locations in the database. In some embodiments, the method 380 can determine the current geographical location using a GNSS receiver or another suitable device for geolocating the vehicle 100 (e.g., a vehicle tracking device). The GNSS receiver may provide current location coordinate values of the vehicle. In some embodiments, the current geographical location can be an area. For example, the area can be an area extending radially from the current location coordinate values (e.g., a circular area having a radius and an origin at estimated coordinate values).

The method 380 can determine if the current geographical location of the ground working vehicle corresponds to a geographical location included in the plurality of geographical locations by determining if the current geographical location overlaps a geographical location included in the plurality of geographical locations. For example, the method 380 may compare the coordinate values and/or area of the current geographical location of the ground working vehicle to each geographical location included in the plurality of geographical locations. If the coordinate values and/or area of the current geographical location are included in an area included in a geographical location included in the plurality of geographical locations, the method 380 can determine that the current geographical location corresponds to the geographical location included in the plurality of geographical locations.

If the method 380 determines that the current geographical location of the ground working vehicle does not correspond to a geographical location included in the plurality of geographical locations, (i.e., “NO” at 386), the method 380 can proceed again to 386. If the method 380 determines that the current geographical location of the ground working vehicle corresponds to a geographical location included in the plurality of geographical locations, (i.e., “YES” at 386), the method 380 can proceed to 388.

The method 380 may also include controlling at 388 operation of the ground working vehicle based on the specific value for the at least one operating parameter for the current geographical location. The geographical location included in the plurality of geographical locations that corresponds to the current geographical location of the ground working vehicle includes a specific value for at least one operating parameter. Thus, the current geographical location of the ground working vehicle can be associated with the specific value for at least one operating parameter. In some embodiments, to control operation of the ground working vehicle, the method 380 can include notifying, alerting, and/or advising an operator of the ground working vehicle of the specific value. In some embodiments, the ground working vehicle may be disengaged if not set to the correct specific value. In some embodiments, the one or more operating parameters of the vehicle may be automatically adjusted. For example, the method may automatically update to be equal to the specific value. In some embodiments, the operator may be prompted to change the one or more operating parameters to the specific value upon pressing a button (e.g., the button 160) or other interface element (e.g., the interface elements 154).

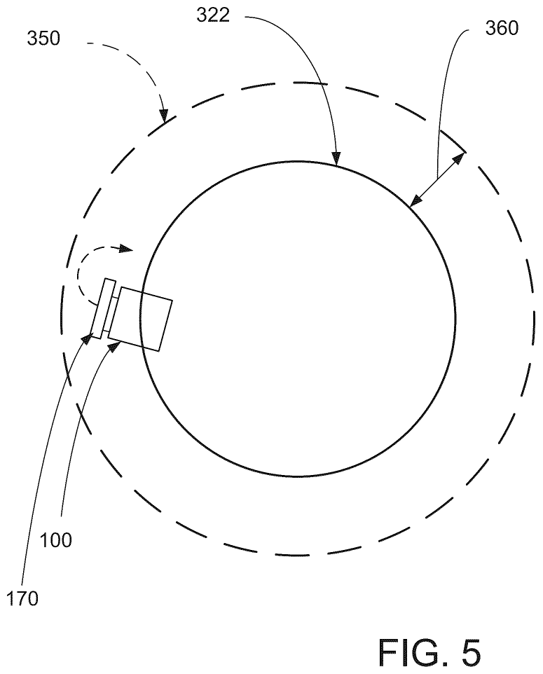

To accommodate the physical size and operational (e.g., turning) parameters of the vehicle 100, the boundary of any one or more geographical locations may, for some purposes, be variable (e.g., larger or smaller) than the predefined discrete boundary of the property. For example, FIG. 5 illustrates a predefined geographical location or property 322 similar to the any one of the properties 220, 22, 224, 226 described above. While operating within the property 322, the vehicle 100 may momentarily exit the property boundary to, for example, turn and/or align an implement 170 (e.g., chemical applicator) for a subsequent pass over the property. In applications where time within the property 322 is recorded, it is beneficial not to disable the timer every time the vehicle moves beyond the boundary for such purposes. Accordingly, a virtual, expanded boundary 350 may be created that is offset from the property 322 boundary by a distance 360 sufficient to permit the vehicle to maneuver effectively while treating the area within the property 322, but without tripping the timer on each occurrence of the vehicle momentarily exiting the boundary of the property 322. The offset distance 360 may vary based upon, for example, vehicle size, size and relative location of the implement 170, turning radius of the vehicle, and similar parameters. Moreover, in some embodiments, the distance 360 may dynamically adjust based upon various operating parameters, e.g., speed of the vehicle 100. Accordingly, the boundary of the property may be considered to have “hysteresis,” whereby a vehicle timer may start upon the vehicle crossing into the property 322 and continue to record even while the vehicle is outside the boundary of the property 322, but within the expanded boundary 350.

Illustrative embodiments are described and reference has been made to possible variations of the same. These and other variations, combinations, and modifications will be apparent to those skilled in the art, and it should be understood that the claims are not limited to the illustrative embodiments set forth herein.

What is claimed is:

1. A method comprising:
storing a plurality of geographical locations in a database, each geographical location included in the plurality of geographical locations comprising an area;
providing a specific value for at least one operating parameter of a ground working vehicle for each geographical location included in the plurality of geographical locations in the database;
determining that a current geographical location of the ground working vehicle corresponds to one of the geographical locations included in the plurality of geographical locations in the database based on the plurality of geographical locations in the database and the current geographical location of the ground working vehicle; and
in response to determining that the current geographical location of the ground working vehicle corresponds to the one of the geographical locations included in the plurality of geographical locations in the database, controlling operation of the ground working vehicle based on the specific value for the at least one operating parameter for the current geographical location.

2. The method of claim 1, wherein controlling operation of the ground working vehicle comprises:
alerting an operator of the ground working vehicle about the specific value for the at least one operating parameter for the current geographical location.

3. The method of claim 1, wherein controlling operation of the ground working vehicle comprises:
determining that a current value for the at least one operating parameter is not equal to the specific value for the at least one operating parameter for the current geographical location, and
disengaging the ground working vehicle if the current value is not equal to the specific value.

4. The method of claim 1, wherein controlling operation of the ground working vehicle comprises automatically setting a stored value of the at least one operating parameter to the specific value for the current geographical location.

5. The method of claim 1, wherein controlling operation of the ground working vehicle comprises:
prompting an operator of the ground working vehicle to engage a button configured to control a value of the at least one operating parameter; and
modifying the at least one operating parameter to the specific value upon engagement of the button.

6. The method of claim 1, wherein controlling operation of the ground working vehicle comprises:
prompting an operator of the ground working vehicle to engage an interface element configured to control a value of the at least one operating parameter; and
modifying the at least one operating parameter to the specific value upon engagement of the interface element.

7. The method of claim 1, wherein controlling operation of the ground working vehicle comprises displaying at least one of the specific value, a current value, and a stored value of the at least one operating parameter.

8. The method of claim 1, wherein the ground working vehicle comprises an implement, and the at least one operating parameter comprises one or more of: a vehicle speed; a height of the implement relative to a ground surface; a rake angle of the implement relative to the ground surface; a position of a baffle of the implement; a treating material application rate of the implement; and a spacing of the implement.

9. A ground working vehicle comprising:
one or more actuators configured to control one or more operating parameters associated with the ground working vehicle; and
one or more controllers coupled to the one or more actuators and configured to:
determine that a current geographical location of the ground working vehicle corresponds to a geographical location included in a plurality of geographical locations stored in a database based on the plurality of geographical locations in the database and the current geographical location of the ground working vehicle, wherein each geographical location included in the plurality of geographical locations comprises an area and corresponds with a specific value for each of the one or more operating parameters; and
in response to determining that the current geographical location of the ground working vehicle corresponds to the geographical location included in the plurality of geographical locations stored in the database, control operation of the ground working vehicle based on the specific value for each of the one or more operating parameters.

10. The ground working vehicle of claim 9, wherein the one or more controllers is configured to alert an operator of the ground working vehicle about the specific value for each of the one or more operating parameters.

11. The ground working vehicle of claim 9, wherein the one or more controllers is configured to:
determine that a current value for the one or more operating parameters is not equal to the specific value for the one or more operating parameters for the current geographical location; and
in response to determining that the current value for the one or more operating parameters is not equal to the specific value, disengage the ground working vehicle.

12. The ground working vehicle of claim 9, wherein the one or more controllers is configured to automatically set a stored value of the one or more operating parameters to the specific value for the one or more operating parameters.

13. The ground working vehicle of claim 9, further comprising a button operatively coupled to the one or more controllers and configured to control at least one value of the one or more operating parameters, and wherein the one or more controllers is configured to:
prompt an operator of the ground working vehicle to engage the button; and
modify the at least one value of the one or more operating parameters of the ground working vehicle to the specific value upon engagement of the button.

14. The ground working vehicle of claim 9, further comprising a display coupled to the one or more controllers, and wherein the one or more controllers are configured to display at least one of the specific value, a current value, and a stored value of the one or more operating parameters.

15. The ground working vehicle of claim 9, further comprising an implement, and wherein the one or more operating parameters comprises one or more of: a vehicle speed; a height of the implement relative to a ground surface; a rake angle of the implement relative to the ground surface; a position of a baffle of the implement; a treating material application rate of the implement; and a spacing of the implement.

16. A ground working vehicle system comprising:
a ground working vehicle comprising:
an actuator configured to control an operating parameter associated with the ground working vehicle; and
a controller operatively coupled to the actuator; and
a database comprising:
a plurality of geographical locations, each geographical location included in the plurality of geographical locations comprising an area; and
a specific value for the operating parameter associated with the ground working vehicle for each geographical location included in the plurality of geographical locations, the controller configured to:
determine that a current geographical location of the ground working vehicle corresponds to one of the geographical locations included in the plurality of geographical locations in the database based on the plurality of geographical locations in the database and the current geographical location of the ground working vehicle; and
in response to determining that the current geographical location of the ground working vehicle corresponds to the one of the geographical locations included in the plurality of geographical locations in the database, control operation of the ground working vehicle based on the specific value for the operating parameter.

17. The ground working vehicle system of claim 16, wherein the controller is configured to automatically set a stored value of the operating parameter to the specific value for the operating parameter for the current geographical location.
